(19) United States
(12) Patent Application Publication
(10) Pub. No.: US 2005/0129844 A1
(43) Pub. Date: Jun. 16, 2005

(54) Method of deposition of nano-particles onto micro and nano-structured materials

(76) Inventors: Colleen Legzdins, West Vancouver (CA); Marek Pawlik, Vancouver (CA)

Correspondence Address: ANGSTROM POWER;GERALD FRANCIS MCLEAN, 1776 YORKTOWN STREET, SUITE 550, HOUSTON, TX, 77056, US

(21) Appl. No.: 10/781,386

(22) Filed: Feb. 18, 2004

Related U.S. Application Data
(60) Provisional application No. 60/476,407, filed on Jun. 6, 2003.

(51) Int. Cl. B05D 1/12; B05D 1/18

(52) U.S. Cl. 427/180; 427/429; 427/430.1

(57) ABSTRACT

The invention is a method for depositing nano-particles on micro-structured objects that have features with sizes measured in microns or smaller by forming a nano-particle dispersion having a polymer with an acrylate, a metal component, a carrier, and nano-particles with a mean average diameter of less than about 10 nm, then coating a micro-structured object with dimensions of between 50 nanometers and 200 microns with the nano-particle dispersion and penetrating nano-particles from the nano-particle dispersion into the features forming a nano-composite.

### FIELD

The present invention relates to a method for depositing nano-particles on micro-structured objects that have features with sizes measured in microns or smaller.

### BACKGROUND

The present application claims priority to co-pending U.S. Provisional Patent Application Ser. No. 60/476,407 filed on Jun. 6, 2003.

Many applications of materials require the use of very fine particles to achieve some objective. In catalytic reactions, not only the catalyst material but also the morphology of the catalyst and its physical relationship to other components of a reactor are important. Therefore there is a need to develop methods of creating catalyst particles of a defined and controlled shape, and of depositing these particles onto reactor elements.

In non-catalytic applications, the ability to create controlled size distribution of small particles is important. For instance, in plating microstructures to render them electrically conductive, in forming nano-layers on a substrate, in creating alloys by multiple application of different materials.

Production and deposition of nano-particles is a difficult process. Various methods exist for using nano-particle precursors with a material to reduce the precursor to a nano-particle on the surface of the bulk material. However, the size distribution of the resulting nano-particles is wide and only limited control is available. Upon heating, sintering occurs and small particles are lost.

Deposition methods including Physical, Vapour and Chemical deposition can coat a thin film of material onto a structure. This yields a smooth surface on uniform thickness on the structure, which is often not desirable. Also, in high aspect ratio microstructures the vapour material is unable to penetrate to the extreme ends of the structures features.

Slurry casting can be used to deposit materials, but the particle size tends to be large (>1 um).

In general, depositing nano-particles onto a structure, particularly a micro-structure presents difficulties in materials handling, difficulty in controlling the particle size and maintaining the particle size through the deposition process, difficulty in achieving uniform deposition over an entire structure and difficulty achieving optimum particle size upon completion of the deposition process. A need exists for a method of depositing nano-particles onto complex structured substrates that is low cost, that maintains control over particle morphology and that does not involve the use of expensive high energy processes or complex environmental control.

Production of the nano-particles themselves also presents a difficulty. Many nano-particles are made in a dry form by mechanically milling precursor materials to produce nano-powders. Controlling the dispersion of these nano-powders to avoid health risks is both difficult and expensive. Furthermore, converting such nano-powders into a form suitable for deposition requires further processing introducing unnecessary costs in production. Furthermore, the use of mechanical milling to produce nano-powders creates challenges in forming the required control of both particle size and particle morphology.

A need exists to create nano-particles in a form compatible with deposition methods that provide the ability to control the distribution of the particle size, that produces particles with desirable morphology and that does not impose health risks.

### SUMMARY

The current invention provides a method for depositing nano-particles on micro-structured objects that have features with sizes measured in microns or smaller. A nano-particle dispersion is initially formed, then a micro-structured object with a dimension between 50 nanometers and 200 microns is coated with the nano-particle dispersion. The coating occurs by depositing the nano-particles of the nano-particle dispersion and penetrating into the micro-structured object forming a nano-composite.

### BRIEF DESCRIPTION OF THE DRAWINGS

The present invention will be explained in greater detail with reference to the appended figures, in which:

FIG. 1 depicts a conventional fuel cell electrode formed from a micro-porous monolith onto which a catalyst layer has been formed using the present invention.

FIG. 2 depicts a cross-section of a novel micro-structured fuel cell geometry formed by micromachining a micro-structured monolith onto which a catalyst layer has been deposited using the present invention.

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

The invention is a method for depositing nano-particles on micro-structured objects. The invention is for micro-structured objects with features that have sizes measured in microns or smaller. Examples of the features are pores, capillaries, channels, voids, ridges, fins, embossments, and combinations thereof. The sizes of the pores, capillaries, or voids are contemplated to be between 25 nanometers and 10 microns. The sizes of the pores, channels, ridges, fins, or embossments are small enough to have an aspect ratio greater than 2 and an overall width between 100 nanometers and 200 microns.

Micro-structures and nano-structures refer to materials that have feature sizes that are measured in microns or smaller. The features can be formed into the material to create a patterned microstructures.

Micro-structured materials are used in many practical applications including filtration, production of electronic components, micro-sensors, fuel processing, electrochemical cells, and fuel cells.

Non-porous materials into which micro-structures are commonly formed comprise silicon wafers, alumina, various ceramics, metals and plastics. These materials are processed using methods, such as laser ablation, wet etching, deep reactive ion etching, electro-discharge machining, dicing, waterjet cutting, micro-injection molding, casting or molding.

Porous media with defined micro-structures typically have pore sizes ranging from less than 1 nm to 10 microns, more preferably between 20 nm and 100 nm. Porous media with micro-pores can be an aero-gel, a foam, or a mat or felt of conductive and non-conductive materials. The porous media can be porous plastics and ceramics.

In electrochemical cell applications, including fuel cells, it is desirable to combine the micro-structured porous material properties with the micro-structural formation to integrate a three-dimensional topology with the natural micro-structure of the porous material. Such integrated structures can be formed from monoliths of porous media by machining, by molding, or by compressing or sintering micro-powders into a mold to create the desired micro-structured, micro-porous shape.

Nano-structured materials are porous materials with features sizes measured on the order of nano-meters or Angstroms. Nano-structured materials are formed in a similar manner to the micro-structured materials.

Creation of complex microstructures using micro-structured materials presents challenges for the creation of composite structures. Composite structures can be formed by the deposition of one or more metals onto or into a microstructure to render the surfaces of the microstructure catalytically active. The deposition of conductive materials onto a microstructure renders the structure conductive. Graded porosity is created by selectively filling micro-pores with a barrier material or the deposition of micro-particles of micro-porous materials onto some macro-porous carrier.

In all these applications, the deposition of nano-particles and nano-crystals onto a microstructure is difficult using conventional particle deposition techniques. Electro-phoretic deposition and electroplating cannot work with nano-sized particles, physical vapour deposition techniques can coat the visible surfaces only, with a uniform film, and do not provide the opportunity for mixing multiple materials on the micro-structured surface. Furthermore, vapour deposition methods cannot penetrate deeply enough into a structures micro-features.

The method of depositing nano-particles and nano-crystals directly onto and into microstructures uses high concentration nano-particle dispersions. These dispersions have been formulated to provide very stable high concentration dispersions of nano-particles or nano-crystals in a carrier liquid having very low overall viscosity. The colloidal dispersion is then easily deposited on a microstructure whereupon the capillary interaction of the microstructure and the colloidal dispersion pulls the liquid into the structure. The suspended nano-particles then interact with the microstructure and are pulled out of the dispersion. Heat treating or otherwise post-treating the deposited particles strengthens the adhesion of the particles to the substrate.

The very small feature sizes of the micro-structured material, whether they are porous or non-porous makes them behave like capillaries. Before providing an example of the method, we will explain the theory of capillary action.

The spontaneous flow of a liquid through a capillary is normally described in terms of the Washburn equation:

$$\frac{{h}^{2}}{t} = \frac{r {γ}_{LV} cos Θ}{2 η}$$

where t is the time needed for a liquid to reach the penetration height/depth of h, r is the capillary radius, γ_{LV} the liquid surface tension, η is the liquid viscosity, and Θ is the three-phase contact angle between the liquid, its saturated vapor and capillary wall.

All porous materials are conveniently treated as consisting of bundles of capillaries that can be characterized by some effective radius r_{eff} given by the following equation:

$${r}_{eff} = \frac{2 ( 1 - ϕ )}{{ϕρ}_{S} A}$$

where ø is the volume fraction of solid in the porous material, ρₛ is the density of solid, and A is the specific surface area per gram of solid.

As the Washburn equation indicates, the penetration rate reaches a maximum value when the liquid completely wets the capillary walls (Θ=0). In the case of hydrophobic solids, such as porous carbons, characterized by large water contact angles (Θ≈90 deg), penetration rates are extremely low but this effect can partly be compensated by using a material with a higher value of r_{eff}, i.e. a material with a small internal specific surface area A. Such capillary size effects were clearly observed in studies using materials with varying porosity. While the deposition of platinum nano-particles from aqueous dispersions was almost impossible in highly porous and hydrophobic substrates, the same type of substrate with a lower porosity could easily be saturated with aqueous platinum nano-dispersions.

Highly hydrophobic solids are easily wetted (Θ=0) by organic solvents with low surface tensions γ_{LV}, such as the solvent methanol. Therefore, the penetration rates of highly porous and strongly hydrophobic substrates can significantly be increased using water/methanol mixtures. Platinum catalyst particles are dispersed in a polymer solution. The polymer is absorbed onto the internal surfaces of the hydrophobic substrate during deposition rendering these surfaces strongly hydrophilic (Θ=0), thus dramatically increasing the penetration rates. This allows the catalyst to be deposited uniformly within a certain volume of the substrate.

Example. In fuel cells, an electrochemical cell is formed by the association of an electrolyte with catalyzed electrodes. Typically, these electrodes are formed by the deposition of supported catalysts onto a porous gas diffusion electrode. Typical pore sizes are larger than 2 microns, with catalyst supported on the micro-porous materials in particles several microns in diameter.

Fuel cells can support the use of micro-structured gas diffusion media directly, but the use of the supported catalyst is problematic in such cases as the size of the supported catalyst particles is too large compared to the feature size of the microstructure.

The method begins by forming a nano-particle dispersion. The nano-particle dispersion is made of a polymer with an acrylate, a metal component, and a carrier. In the preferred embodiment, the nano-particle dispersion has a mean average diameter of less than about 10 nm, preferably between 3 nm and 5 nm. The nano-particles can be crystals.

The micro-structured object is then coated with the nano-particle dispersion. The micro-structured object has dimensions between 50 nanometers and 200 microns, preferably between 50 nanometers and 100 microns. Examples of micro-structured objects are materials containing a microstructure, porous materials with micro-pores, materials into which a microstructure pattern has been formed, and any combinations thereof.

The final step of the method entails penetrating nano-particles from the nano-particle dispersion into the features forming a nano-composite, forming the layers of the fuel cell.

The acrylate in the polymer can be sodium acrylate, potassium acrylate, calcium acrylate, or combinations thereof.

The metal component used is a transition metal, a metal oxide, or combinations thereof. The concentration of the metal component in the nano-particle dispersion is at least about 30%. Examples of transition metals that can be used are platinum, ruthenium, palladium, gold, and combinations thereof. Examples of metal oxides include iron oxide, titanium oxides, transition metal oxides, and other such materials.

The carrier in the nano-particle dispersion is either water or an alcohol with a lower surface tension than water. The types of water envisioned as useable in the method are deionized water and distilled water. Methanol, ethanol, propanol, and combinations thereof are the types of alcohol that can be used.

In a preferred embodiment, the nano-particle dispersion is thermodynamically stable at room temperature and has a viscosity of between 20 centipoises and 300 centipoises. The nano-particle dispersion may further include an ultraviolet stabilizer.

The deposition can be repeated a set number of time or “n” times. Preferably, the “n” number of times is greater than two in order to form a nano-composite. A second material with similar properties can be deposited on the nano-composite prior to repeating each deposition.

The dispersion can be sprayed on the micro-structured object. Alternatively, the resultant coating can be accomplished by soaking the micro-structured object in the nano-particle dispersion. The coating of the dispersion on the micro-structured object can also be performed by painting, printing, dipping, dripping, and combinations thereof. The dripping is performed by using a computed volume of dispersion to coat a known mass of nano-particles on the micro-structured object.

In another embodiment, the method can include the step of depositing “n” nano-particle dispersions comprising a metal component that is different from prior dispersion metal components. Preferably, the “n” number of times is greater than two in order to form a nano-composite.

This second nano-particle dispersion has a different transition metal or different metal oxide metal then the first nano-particle dispersion. The second nano-particle dispersion can be a metal oxide and the first nano-particle dispersions can be a transition metal and vice versa. Together, the first disposition and a second disposition of a different metal form a “nano-alloy”.

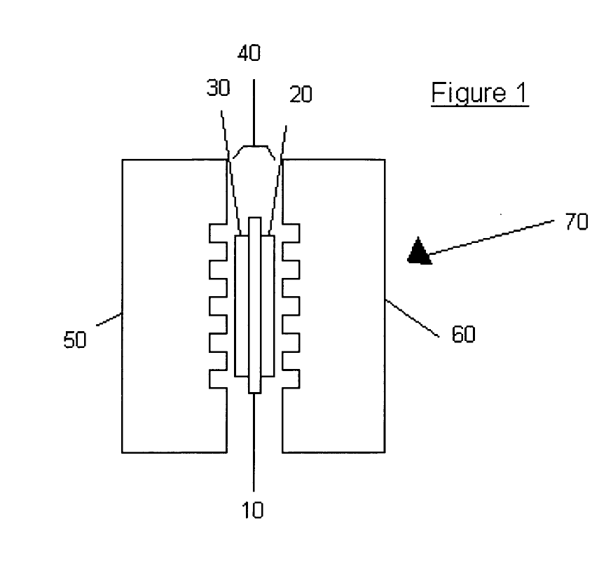

The invention is further explained with reference to the figures. FIG. 1 depicts a planar electrode (10) that in this case is micro-structured. The electrode is made of carbon aero-gel, metal foam, carbon foam, reticulated carbon foam or a variety of ceramics. The catalyst (20) consists of micro-particles that are deposited and bonded to the micro-structured electrode. The catalyst particles (20) reside on the surface (30) and the interior (40) of the electrode.

The catalyzed electrode structure of FIG. 1 is prepared from a colloidal dispersion of platinum nano-crystals made stable through the addition of polyacrylate to the colloidal solution. The low viscosity colloidal particle dispersion was applied directly to the micro-porous electrode, which in this case was either a nano-structured carbon foam, or a nano-structured plate of magneli phase porous titanium oxide.

The nano-particle dispersion was sprayed onto the surface, but in alternative embodiments the dispersion can be painted, dipped, brushed, screen printed or sponged onto the surface. When the colloidal dispersion touches the surface, the capillary action of the microstructure pulls the dispersion into the surface so that both the electrode surface (30) and the interior (40) are coated with nano-particles. By adjusting the viscosity, solvent content and temperature of the colloidal dispersion, the depth of penetration of the colloidal dispersion into the interior of the structure can be controlled. The hydrophobicity of the micro-structured surface can also be used to control the depth of penetration into the microstructure.

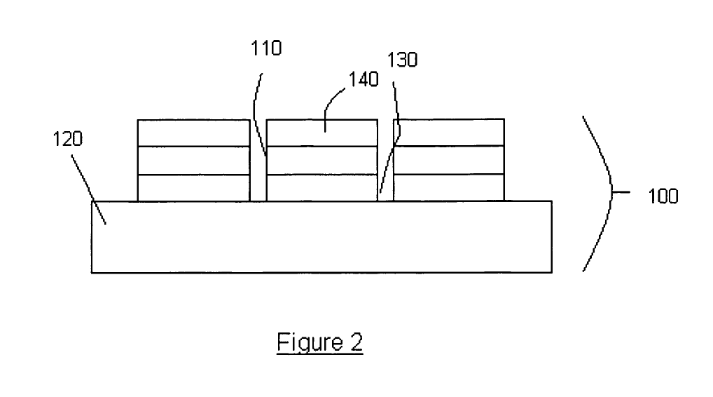

FIG. 2 shows an embodiment wherein the colloidal dispersion deposits nano-particles into a high aspect ratio microstructure. In this figure, a porous substrate (100) has micro-channels (110) with very high aspect ratios. The geometric structure of this device is such that conventional methods of particle deposition will not work, since they are incapable of providing uniform coverage deep into the formed micro-structures. Since the substrate (100) is porous, the deposition of nano-particles is required to both coat the surfaces (120) of the microstructure uniformly and also penetrate some depth into the interior of the micro-structured (130). The channels (110) shown in this microstructure are typical of micro structural features, with a channel width between 500 nm and 200 um. More preferably, channels and other features have widths between 5 um and 100 um, with aspect ratios between 1 and 50. By rendering the top (140) of the porous substrate (100) hydrophobic via masking, the nano-particles can be deposited by simply pouring the nano-dispersion onto the surface of the microstructure, whereupon the capillary action of the micro-features pulls the liquid into the structure and the microstructure of the porous material further pulls the liquid into the substrate itself.

In an alternative method of deposition, the nano-dispersion can be pumped into the microstructure, painted, sprayed, dipped or otherwise brought into contact with the surface of the microstructure to form the filled structure.

While this invention has been described with emphasis on the preferred embodiments, it should be understood that within the scope of the appended claims, the invention might be practiced other than as specifically described herein.

1. A method for depositing nano-particles on micro-structured objects wherein the micro-structured object comprise features having sizes measured in microns or smaller, wherein the method comprises the steps of:
a. forming a nano-particle dispersion comprising;
i. providing a polymer comprising an acrylate;
ii. providing a metal component; and
iii. providing a carrier;
wherein the resultant nano-particle dispersion comprises nano-particles having a mean average diameter than about 10 nm or less;
b. coating a micro-structured object having features formed thereon, wherein each of the features have a dimension of between 50 nanometers and 200 microns with the nano-particle dispersion forming a nano-composite.

2. The method of claim 1, wherein the nano-particles are crystals.

3. The method of claim 1, wherein the micro-structured objects comprise a material containing a microstructure, a porous material with micro-pores, a material into that a microstructure pattern has been formed, and combinations thereof.

4. The method of claim 1, wherein the dimension is between 50 nanometers and 100 microns.

5. The method of claim 1, wherein the acrylate comprises a sodium acrylate, a potassium acrylate, a calcium acrylate and combinations thereof.

6. The method of claim 1, wherein the metal component comprises a transition metal, a metal oxide, and combinations thereof.

7. The method of claim 6, wherein the transition metal comprises platinum, ruthenium, palladium, gold, and combinations thereof.

8. The method of claim 1, wherein the carrier comprises water and an alcohol with a lower surface tension than water.

9. The method of claim 8, wherein the alcohol comprises a methanol, ethanol, propanol, and combinations thereof.

10. The method of claim 8, wherein the water comprises deionized water, and distilled water, and combinations thereof.

11. The method of claim 6, wherein the metal oxides comprise iron oxide, titanium oxides, transition metal oxides, and combinations thereof.

12. The method of claim 1, wherein the dispersion comprises a nano-particle concentration of at least about 30% of the metal component.

13. The method of claim 1, wherein the nano-particles have a mean average diameter of between 3 nm and 5 nm.

14. The method of claim 1, wherein the dispersion is thermodynamically stable at room temperature.

15. The method of claim 1, wherein the dispersion has a viscosity of between 20 centipoids and 300 centipoids.

16. The method of claim 1, wherein the dispersion further comprises an ultraviolet stabilizer.

17. The method of claim 1, wherein the features comprise pores, capillaries, channels, voids, ridges, fins, embossments, and combinations thereof.

18. The method of claim 1, wherein each feature comprises a diameter between 25 nanometers and 10 microns.

19. The method of claim 1, wherein the features have an aspect ratio greater than 2 and an overall width between 100 nanometers and 200 microns.

20. The method of claim 1, wherein the step of coating is repeated “n” times, wherein “n” is an integer greater than 2, thereby forming a nano-composite.

21. The method of claim 1, wherein the step of coating is performed by spraying the dispersion on the micro-structured object.

22. The method of claim 1, wherein the step of coating is performed by soaking the micro-structured object in the dispersion.

23. The method of claim 1, wherein the step of coating is by painting, printing, dipping, dripping, or combinations thereof.

24. The method of claim 23, wherein the step of dripping is performed by using a computed volume of dispersion to coat a known mass of nano-particles on the micro-structured object.

25. The method of claim 1, further comprising the step of depositing “n” nano-particle dispersions comprising a metal component that differs from prior dispersion metal components and wherein “n” is an integer greater than 2, thereby forming a nano-alloy.

26. The method of claim 25, wherein the nano-alloy comprises a transition metal different from the nano-particle dispersion.

27. The method of claim 25, wherein the nano-alloy comprises a metal oxide different from nano-particle dispersion.

28. The method of claim 25, wherein the nano-alloy comprises a metal oxide and the nano-particle dispersions comprises a transition metal.
